(19) United States
(12) Patent Application Publication
(10) Pub. No.: US 2015/0198294 A1
(43) Pub. Date: Jul. 16, 2015

(54) LIGHT BAR, BACKLIGHT DEVICE, AND MANUFACTURING METHODS THEREOF

(71) Applicant: SAE Magnetics (H.K) Ltd., Hong Kong (CN)

(72) Inventors: Mark Wing Keung MAK, Hong Kong (CN); Wing Sze CHEUNG, Hong Kong (CN); Brian Ho Tong LEE, Hong Kong (CN); Wing Yiu CHEUNG, Hong Kong (CN)

(21) Appl. No.: 14/594,431

(22) Filed: Jan. 12, 2015

(30) Foreign Application Priority Data
Jan. 13, 2014 (CN) 201410015117.7

(51) Int. Cl. F21K 99/00; F21V 8/00

(52) U.S. Cl. CPC F21K 9/30; G02B 6/0073; G02B 6/0068; F21Y 2103/003

(57) ABSTRACT

A manufacturing method of a light bar includes providing a hard substrate; electrically connecting multiple optical source chips on the substrate, the multiple optical source chips being arranged along a length direction of the substrate in a predetermined spacing; and encapsulating the optical source chips and a top surface of the substrate with encapsulation polymer, thereby a topmost surface of the encapsulation polymer on the optical source chips and the substrate being located at the same level. The light bar obtained has efficient light coupling, simple and efficient manufacturing process, and meets requirements of compact and light product.

### FIELD OF THE INVENTION

The present invention relates to a field of electronic display devices, and more particularly to a backlight device with light bar, specifically to an improved light bar, a backlight device and manufacturing methods.

### BACKGROUND OF THE INVENTION

Nowadays, LEDs served as light sources have been used widely in illumination and display fields. For example, display screen of electronic devices, and LCD are required an outside illumination such as a backlight device, since they are not self-luminous. While the LEDs have replaced the cold cathode fluorescent lamps (CCFL) to serve as the light source for illumination.

FIG. 1a shows a conventional backlight device. As shown, the backlight device 100 includes an LED light bar 110 and a light guide plate 120 connected with the LED light bar 110. The backlight assembly 100 sends the light emitted from the LED light bar 110 to the light guide plate 120, so as to provide illumination for the display screen or LCD plate or other transmission display screen requires backlighting which is placed close to the light guide plate 120.

Commonly, the LED light bar 110 includes multiple LED modules 111 and a PCB substrate 112 connected with the LED modules 111 to supply power. The LED module 111 include LED chips 113, a housing 114 for accommodating the LED chips 113, and encapsulation polymer 115 filling in the recess of the housing 114 for encapsulating the LED chips 113. The encapsulation polymer 115 commonly is made of transparent resin. Light emit from the LED chips 113 enters into the light guide plate 120 most of which is transmitted therein, when reaching to the reflector or diffusion plate (not shown) or pattern on the light guide plate 120, the light will be guided to reach the display screen or LCD plate 130.

Conventionally, the manufacturing method of the LED light bar 110 and the assembly method of the backlight device 100 are explained as following. As shown in FIG. 1b, first, individual LED module 111 is formed. Specifically, every LED chip 113 is disposed on the bottom surface of the housing 114. And then, multiple individual LED modules 111 are connected to a flexure PCB substrate 112 in a predetermined spacing. For meeting the irradiancy demand of the LED, the LED chips 113 can be connected to the PCB substrate 112 in parallel or in series by means of surface leading wire. Finally, resin is filled into the recess of the housing 114 for each LED module 11 to encapsulate them. The light bar 110 after encapsulated is shown in FIG. 1c, as shown, the encapsulation resin is filled in the position that the LED module 111 is located, but not the whole PCB substrate 112. When the light bar 110 is assembled with the light guide plate 120, the matching surface of the light guide plate 120 is shaped with concave-convex portion, for some light guide plate design a straight entrance surface is used, after the light bar 110 and the light guide plate 120 are aligned with each other. The relative position between light bar 110 and light guide plate 120 are fixed by means of adhesion.

As the electronic products require efficient improvement, thinner and compact form factor, this backlight device and the old manufacturing and assembly method have certain drawbacks that are hard to overcome as following.

Since the LED module includes individual housings to support the LED chips, which are connected to the PCB substrate, thus the size of LED module will be limited to become thinner due to the housings, which may not meet the requirements of the thinner light guide plate.

Further to dimension, the LED chip is deposited inside the housing, thus the light emitted will also be confined and reflected by the housing interior. A common trend is that for the conventional housing, efficiency of emitted light that can couple to the light guide plate is reduced as the dimension shrink.

The conventional manufacturing method of the light bar has low efficiency and yield, specially the LED die and LED module need individual mounting process that will increase the process steps and position variation.

As the PCB substrate of the light bar is soft and thin, thus the positioning for the LED module is difficult when the LED module is connected, which causes the LED modules misaligned, thus causes misalignment between the light bar and the light guide plate.

Thus, it is desired to provide an improved light bar, a backlight device and manufacturing methods to overcome the drawbacks mentioned above.

### SUMMARY OF THE INVENTION

One objective of the present invention is to provide a manufacturing method of a light bar, thereby a light bar obtained has efficient light coupling, simple and efficient manufacturing process, and meets requirements of compact and light product.

Another objective of the present invention is to provide a manufacturing method of a backlight device including a light bar, thereby the light bar obtained has efficient light coupling, simple and efficient manufacturing process, and meets requirements of compact and light product.

Another objective of the present invention is to provide a light bar, which has efficient light coupling, simple and efficient manufacturing process, and meets requirements of compact and light product.

Another objective of the present invention is to provide a backlight device including a light bar, which has efficient light coupling, simple and efficient manufacturing process, excellent performance, and meets requirements of compact and light product.

To achieve above objectives, a manufacturing method of a light bar, includes steps of:

providing a hard substrate;

electrically connecting multiple optical source chips on the substrate, the multiple optical source chips being arranged along a length direction of the substrate in a predetermined spacing; and

encapsulating the optical source chips and a top surface of the substrate with encapsulation polymer, thereby a topmost surface of the encapsulation polymer on the optical source chips and the substrate being located at the same level.

Preferably, the method further includes forming electrical pads on a side of the substrate, the electrical pads being connected with an electrode of at least one of the optical source chips.

As a preferred embodiment, said forming the electrical pads on the side of the substrate includes:

forming a through hole at a position of the substrate that is corresponding with the electrode of the optical source chip;

plating conductive material through the through hole; and

cutting the substrate along the through hole with the conductive material therein, thereby a part of the conductive material being exposed at a side of the substrate to form the electrical pad.

Preferably, the method further includes forming electrical pads on a bottom of the substrate, the electrical pads being connected with an electrode of at least one of the optical source chips.

As another embodiment, said encapsulating the optical source chips and the substrate further includes:

filling the optical source chips and the substrate with the encapsulation polymer;

determining the shape of the encapsulation polymer; and

curing the encapsulation polymer.

Preferably, the encapsulation polymer has a bottom surface abutted with the top surface of the substrate, a top surface opposite the bottom surface, and two reflecting surfaces connected with the bottom surface and the top surface, and the two reflecting surfaces in a first predetermined area are gradually narrowed from the top surface to the bottom surface, and the two reflecting surfaces in a second predetermined area are parallel one another.

Preferably, a cross section of the encapsulation polymer is trapezoidal, arc-shaped, triangular, rectangular, or step-shaped.

Preferably, it further includes forming at least one reflecting coating on an upper surface, a lower surface or a side surface of the encapsulation polymer.

Preferably, the encapsulation polymer is made of transparent or translucent material.

Preferably, the encapsulation polymer has an upper portion and a lower portion that have different optical properties.

Accordingly, a manufacturing method of the backlight device includes providing a light bar, a circuit board and a light guide plate; bonding the light bar onto the circuit board, and bonding the light bar to a matching surface of the light guide plate with polymer. And the light bar is made by the manufacturing method mentioned above.

Accordingly, a light bar includes a hard substrate; multiple optical source chips electrically connected on the substrate, the multiple optical source chips being arranged along a length direction of the substrate in a predetermined spacing; and encapsulation polymer covering top surfaces of the optical source chips and the substrate, and a topmost surface of the encapsulation polymer on the optical source chips and the substrate being located at the same level.

Preferably, the encapsulation polymer has a bottom surface abutted with the top surface of the substrate, a top surface opposite the bottom surface, and two reflecting surfaces connected with the bottom surface and the top surface, and the two reflecting surfaces in a first predetermined area are gradually narrowed from the top surface to the bottom surface, and the two reflecting surfaces in a second predetermined area are parallel one another.

Preferably, a cross section of the encapsulation polymer is trapezoidal, arc-shaped, triangular, rectangular, or step-shaped.

Preferably, the encapsulation polymer is made of transparent or translucent material.

Preferably, the encapsulation polymer has an upper portion and a lower portion that have different optical properties.

Accordingly, a backlight device includes a light bar mentioned above, a PCB connected to the light bar, and a light guide plate.

In comparison with the prior art, since the light emitting chips of the present invention are connected to the substrate directly without housing support, thus the size of the light bar can be configured thinner and compact without limitation of the housing, which meets the design demand of the thinner light guide plate. Additionally, the light emitted from the chips may not be confined by the housing, instead is transmitted in the encapsulation polymer, which improves the light coupling efficiency. Furthermore, the light emitting chips and the substrate are covered and coated by the encapsulation polymer, thus the manufacturing process is simplified to reduce the manufacturing time. Further, the substrate in the present invention is hard, which is beneficial to assemble the chips with accurate positioning, also makes the assembly of the light guide plate easier.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a cross section of a conventional backlight device;

FIG. 1b is a cross section of a conventional light bar;

FIG. 1c is a view showing the assembling of the conventional backlight device;

FIG. 2 is a flowchart of a manufacturing method of a light bar according to one embodiment of the present invention;

FIGS. 3a-3d show the manufacturing steps of the light bar according to the present invention;

FIG. 4a is a perspective view of the light bar according to one embodiment of the present invention;

FIG. 4b shows the light bar bonding onto a PCB according to one embodiment of the present invention;

FIG. 5a shows a light bar with electrical pads on the bottom of the substrate;

FIG. 5b shows the light bar as shown in FIG. 5a bonding onto a PCB according to another embodiment;

FIG. 6a-6f shows cross sections of the light bar according to embodiments of the present invention;

FIGS. 7a-7b show the assembling of the backlight device according to two embodiments of the present invention; and

FIG. 7c shows the backlight device after assembled.

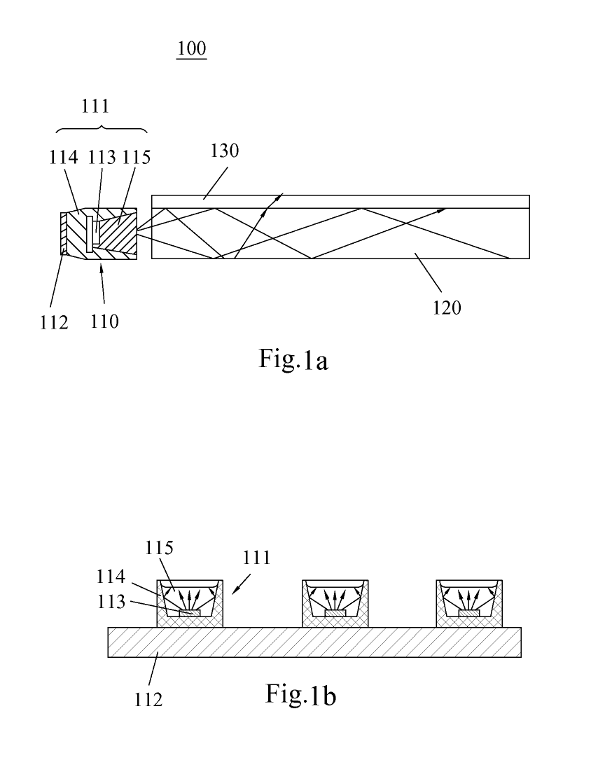

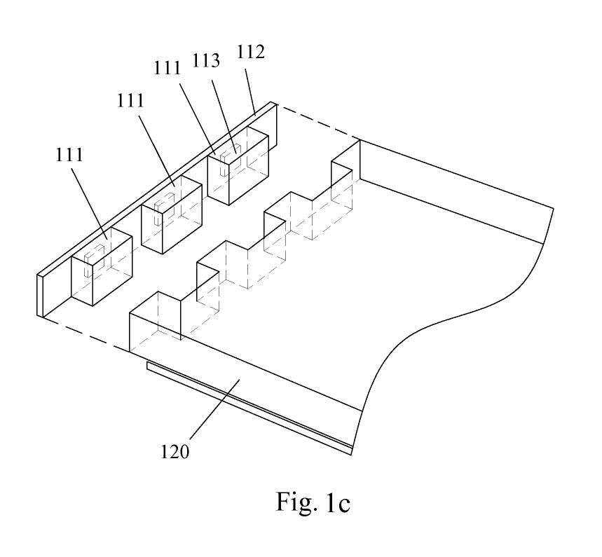

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a light bar, a backlight device and their manufacturing methods, thereby the light bar has efficient light coupling, simple and efficient manufacturing process, and meets requirements of compact and light product. The light bar and backlight device according to the present invention are applicable to any electronic devices which have display screens or LCD requiring backlight devices, such as mobile phone, tablet PC, computer, etc.

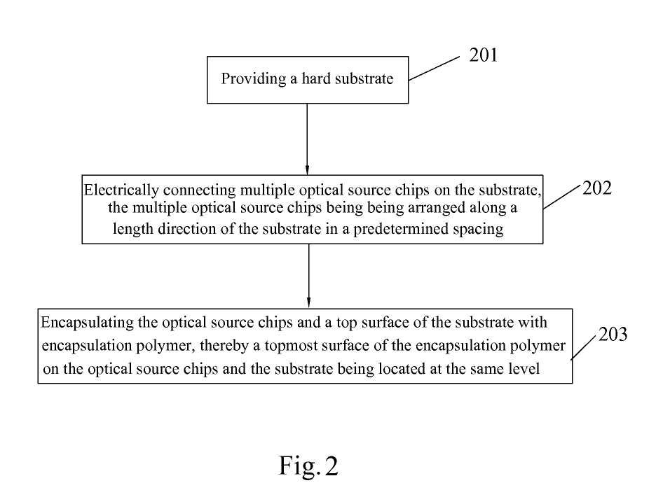

FIG. 2 shows a flowchart of a manufacturing method of a light bar according to one embodiment of the present invention. As shown, the method includes:

Step 201, providing a hard substrate;

Step 202, electrically connecting multiple optical source chips on the substrate, the multiple optical source chips being arranged along a length direction of the substrate in a predetermined spacing;

Step 203, encapsulating the optical source chips and a top surface of the substrate with encapsulation polymer, thereby a topmost surface of the encapsulation polymer on the optical source chips and the substrate being located at the same level.

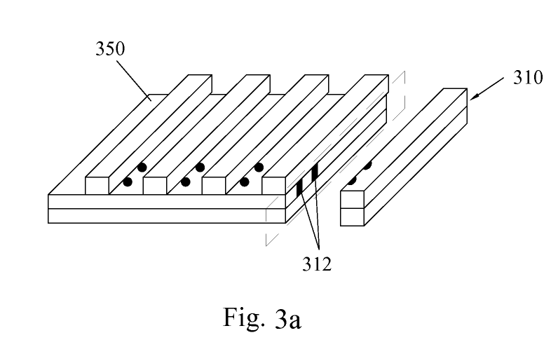

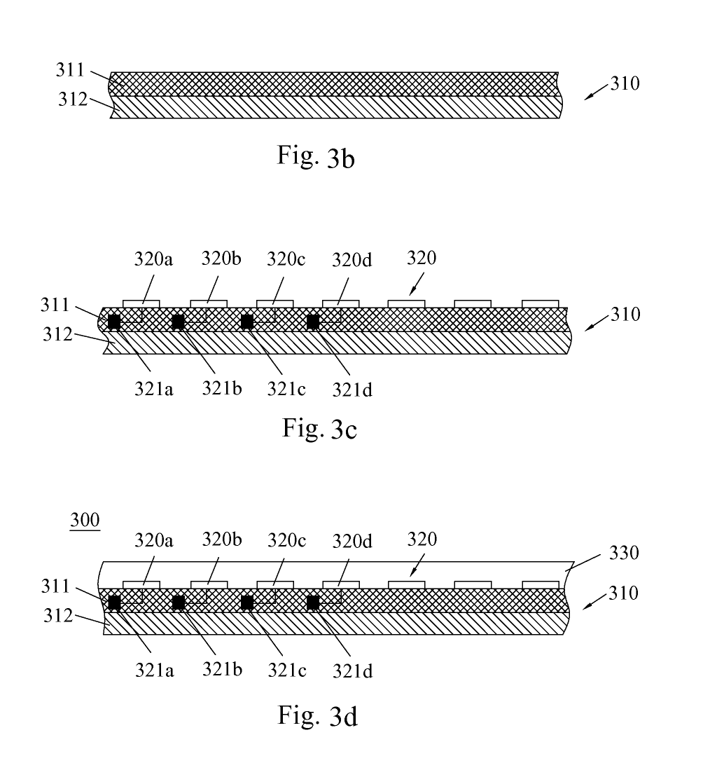

Specifically, detailed manufacturing process of the light bar of the embodiment will be described by combination of FIGS. 3a-3d. In a preferred embodiment, the substrate 310 is shaped as a strip. In the actual manufacturing process, a plate-shaped substrate 350 is provided in advance, which will be cut in the sequent stage of the manufacturing process (after the step 203) to finally obtain the individual strip substrate 310. Of course, the strip substrate 310 can be provided in the step 201.

Preferably, as shown in FIG. 3b, the substrate 310 is a PCB which includes a flexure circuit layer 311 at the upper layer and a support layer 312 at the lower layer.

In the step 202, multiple optical source chips 320 is electrically connected to the substrate 310, and the amount thereof can be selected according to the actual demand. For example, to obtain light on the screen with different colors, multiple groups optical source chips 320 are in parallel connection (such as four groups 320a, 320b, 320c, 320d), therein electrodes 321a, 321b, 321c, 321d of the individual optical chips 320 are configured separately (as shown in FIG. 3b); alternatively, the multiple optical source chips 320 are in serial connection, and the electrode of the last optical source chip 320 is electrically connected to the flexure circuit layer 311.

Specially, two electrical pads 313 are formed at a side of the flexure circuit layer 311 of the substrate 310, which are electrically connected with the electrode 321 of the optical source chip 320 to supply power for it.

It should be noted that, in the present embodiment, the optical source chips 320 are connected to the PCB substrate 310 directly without additional housing, which makes the manufacturing process easier, and its critical advantages will be described in details hereinafter.

In the encapsulation step 203, the filling of the encapsulation polymer 330 can be processed by means of conventional encapsulation manner. Specifically, the step 203 includes: filling the optical source chips 320 and the substrate 310 with the encapsulation polymer 330; determining the shape of the encapsulation polymer 330; and curing the encapsulation polymer 330. It should be noted that, the encapsulation polymer 330 should fully cover the top surfaces of optical source chips 320 and the substrate 310, and the tops of the encapsulation polymers 330 respectively on surfaces of the optical source chips 320 and the substrate 310 are located at the same level. As shown in FIG. 3d, the topmost surface of the light bar 300 is flat, which is different from the conventional one.

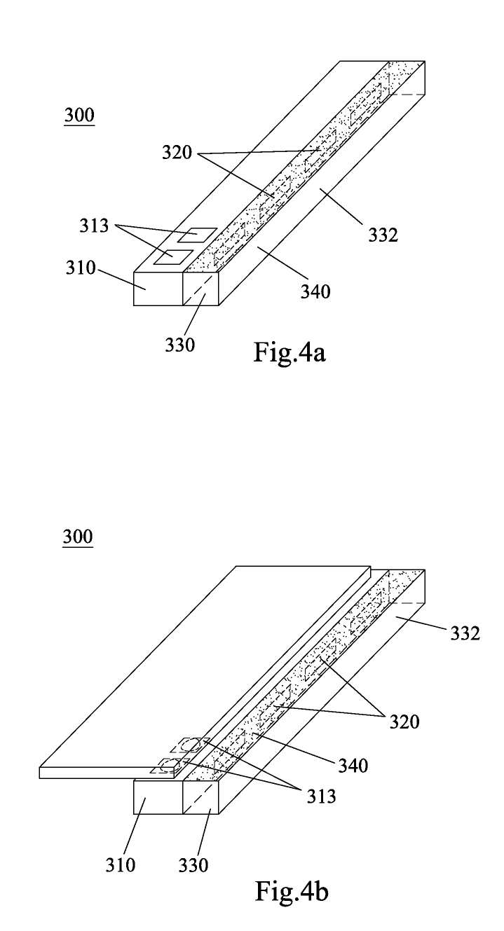

Preferably, regarding the situation that the substrate 310 is formed by cutting the plate-shaped substrate 350, the step of forming electrical pads 313 at the side of the substrate 310 includes the following steps, as shown in FIGS. 3a and 4a:

forming through holes on positions of the substrate 350 that are corresponding with electrodes 321a, 321b, 321c, 321d of the optical source chips 320;

plating conductive material through the through holes; and

cutting the plate-shaped substrate 350 along the through holes with the conductive material therein to form individual strip substrate 310, thereby a part of the conductive material being exposed at a side of the substrate 310 to form the electrical pads 313 as shown in FIG. 4a. FIG. 4b shows the electrical pads 313 are connected to a PCB (printed circuit board) 600.

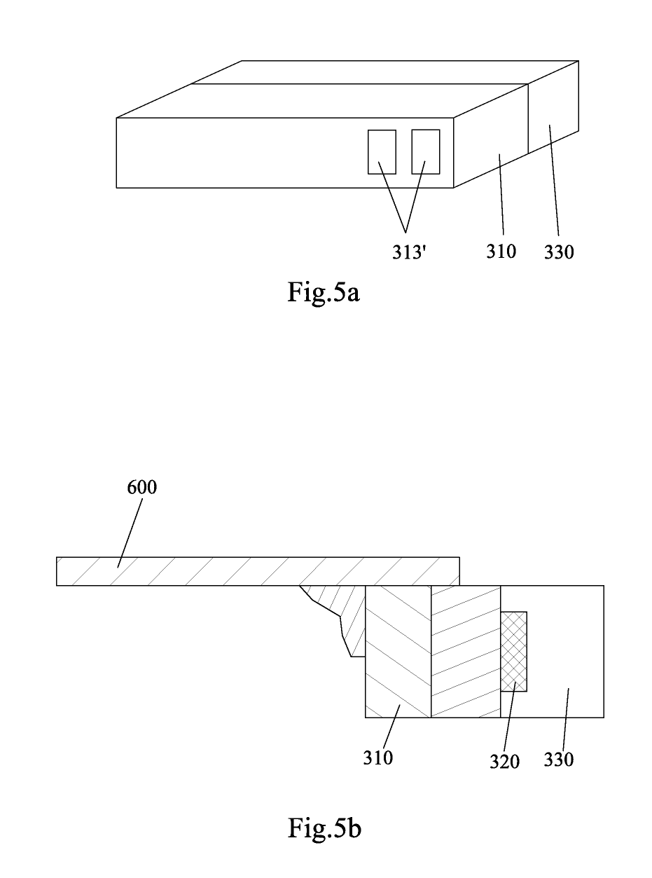

Of course, the electrical pads could be formed on the bottom of the substrate. Please refer to FIG. 5a, the electrical pads 313′ on the bottom are electrically connected to the PCB 600 by solder joints, the bottom bonding way could lead to a more steady connection. Additionally, other ways also could be used to form the electrical pads, such as surface leading wire.

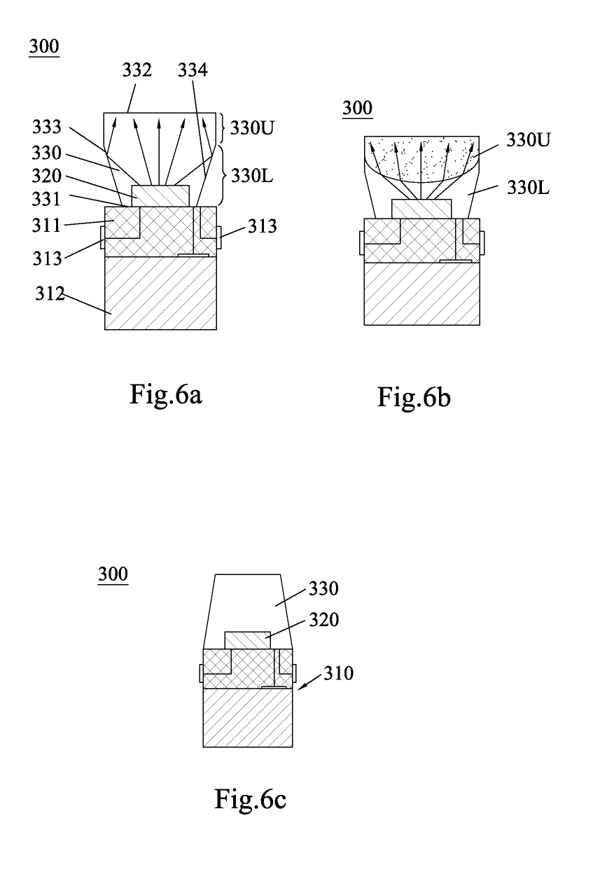

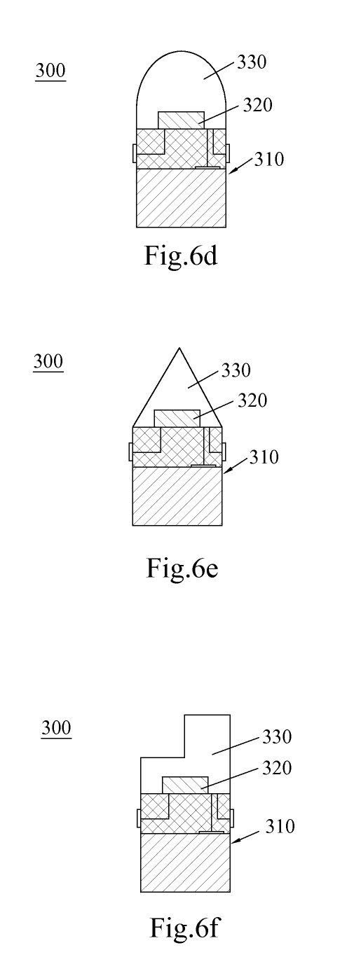

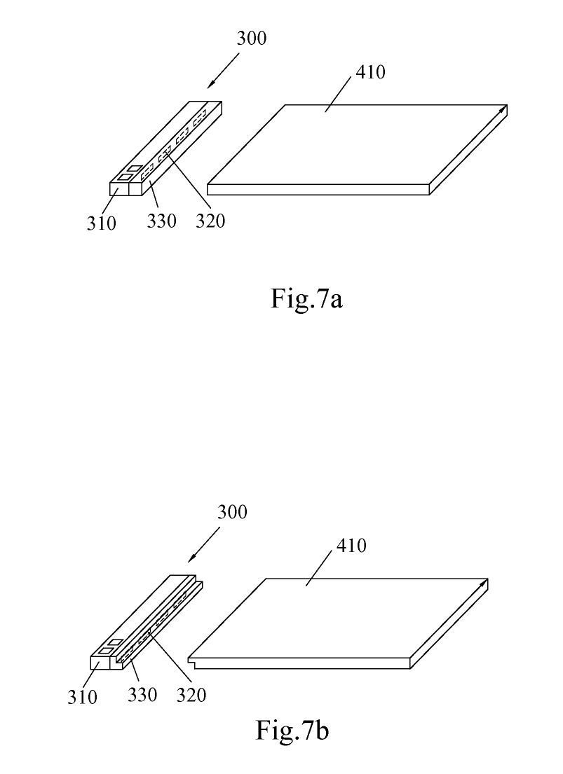

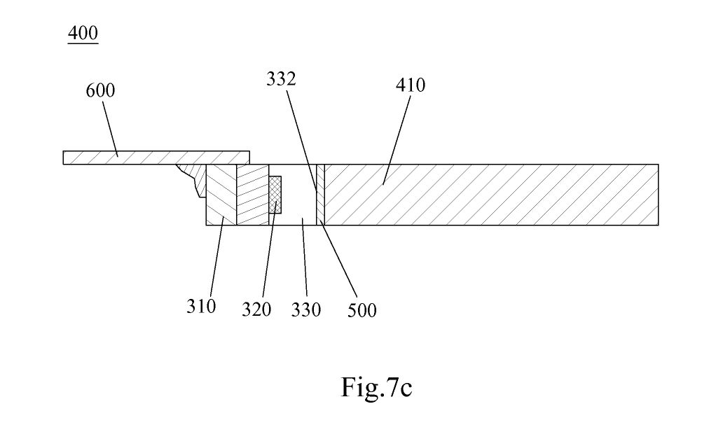

Please refer to FIGS. 4a, 6a-6f, preferred embodiment of the light bar 300 is explained. FIG. 4a just shows the light bar with four optical source chips 320, actually the amount is not limited but depends on the design. Preferably, the optical source chips 320 are LED chips. The material and the shape of the encapsulation polymer can be optimized according to the actual demand. For example, the encapsulation polymer 330 can be made of transparent or translucent material, such as silicone, etc. FIG. 6a shows a cross section of the light bar 300 according to one embodiment. In this embodiment, the encapsulation polymer 330 has a bottom surface 331 abutted with the top surface of the substrate 310, a light emitting surface 332 opposite the bottom surface 331, and two reflecting surfaces 333, 334 connected with the bottom surface 331 and the light emitting surface 332, and the two reflecting surfaces 333, 334 in a first predetermined area (the lower portion 330L) are gradually narrowed from the light emitting surface 332 to the bottom surface 331, and the two reflecting surfaces 333, 334 in a second predetermined area (the upper portion 330U) are parallel one another. Base the configuration of the encapsulation polymer 330, the light emitted from the optical source chips 320 is transmitted in the interior of the encapsulation polymer 330, and then reflected by the reflecting surfaces 333, 334 from the narrow lower portion 330L to the upper portion 330U, and finally emitted from the light emitting surface 332. Therefore, the light coupling efficiency of the light bar 300 is improved, and the light utilization rate is high to cause the light fully transmitted to the light guide plate 410 (referring to FIG. 7a), so as to improve the performance of the backlight device.

As a preferred embodiment, to further improve the light coupling effect and the propagation effect, the encapsulation polymer 330 includes different material with different optical properties, such as different refractive index in the upper portion 330U and the lower portion 330L, as shown in FIG. 6b.

Optionally, the shape of the encapsulation polymer 330 can be different. It could have a trapezoidal, arc-shaped, triangular, or step cross section, but the topmost surface of the encapsulation polymer 330 located above the optical source chips 320 and the substrate 310 is at the same level, seen from the view perpendicular the length direction of the substrate 310, as shown in FIGS. 6c-6f. Furthermore, a reflecting coating 340 may be formed on the upper surface of the encapsulation polymer 330, please refer to FIG. 4a, the reflecting coating 340 prevent the light come out from the upper surface and reflect the light back to the light bar 300, as a result the illumination intensity of the light bar 300 is improved, the reflecting coating 340 could be a white painting, etc. Of course, the reflecting coating 340 also could be formed on other surfaces of the light bar 300 except the light emitting surface 332.

In conclusion, since the light emitting chips 320 of the light bar 300 are connected to the substrate 310 directly without housing support, thus the size of the light bar 300 can be configured thinner and compact without limitation of the housing, which meets the design demand of the thinner light guide plate. Additionally, the light emitted from the chips may not be confined by the housing, instead is transmitted in the encapsulation polymer 330, which improves the light coupling efficiency. Furthermore, the light emitting chips 320 and the substrate 310 are covered and coated by the encapsulation polymer 330, thus the manufacturing process is simplified to reduce the manufacturing time. Further, the substrate 310 in the present invention is hard, which is beneficial to assemble the chips 320 with accurate positioning, also makes the assembly of the light guide plate easier.

FIGS. 7a-7c show the assembling of the backlight device 400 according to the present invention. During the assemble process, For matching the shape of the encapsulation polymer 330, the matching surface of the light guide plate 410 can be shaped according to the shape of the encapsulation polymer 330, as shown the flat surface in FIG. 7a, or the step-surface in FIG. 7b, which is not described in details. Refer to FIG. 7c, in order to make the backlight device 400 more stable, we could add a heterogeneous polymer 500 between light emitting surface 332 and the light guide plate 410, the heterogeneous polymer 500 can be a thin layer of UV epoxy or alike which could be cured to hold the light bar 300 and the light guide plate 410 together and allow the light to transmit through.

Based on the structure and the manufacturing method, the backlight device 400 has simple and quick assembling process, high light coupling efficiency, excellent product performance, and meets the requirements of the thin and compact for the electronic products.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A manufacturing method of a light bar, comprising steps of:
providing a hard substrate;
electrically connecting multiple optical source chips on the substrate, the multiple optical source chips being arranged along a length direction of the substrate in a predetermined spacing; and
encapsulating the optical source chips and a top surface of the substrate with encapsulation polymer, thereby a topmost surface of the encapsulation polymer on the optical source chips and the substrate being located at the same level.

2. The manufacturing method according to claim 1, further comprising forming electrical pads on a side of the substrate, the electrical pads being connected with an electrode of at least one of the optical source chips.

3. The manufacturing method according to claim 2, wherein said forming the electrical pads on the side of the substrate comprising:
forming a through hole at a position of the substrate that is corresponding with the electrode of the optical source chip;
plating conductive material through the through hole; and
cutting the substrate along the through hole with the conductive material therein, thereby a part of the conductive material being exposed at a side of the substrate to form the electrical pad.

4. The manufacturing method according to claim 1, further comprising forming electrical pads on a bottom of the substrate, the electrical pads being connected with an electrode of at least one of the optical source chips.

5. The manufacturing method according to claim 1, wherein said encapsulating the optical source chips and the substrate further comprises:
filling the optical source chips and the substrate with the encapsulation polymer;
determining the shape of the encapsulation polymer; and
curing the encapsulation polymer.

6. The manufacturing method according to claim 1, wherein the encapsulation polymer has a bottom surface abutted with the top surface of the substrate, a top surface opposite the bottom surface, and two reflecting surfaces connected with the bottom surface and the top surface, and the two reflecting surfaces in a first predetermined area are gradually narrowed from the top surface to the bottom surface, and the two reflecting surfaces in a second predetermined area are parallel one another.

7. The manufacturing method according to claim 1, wherein a cross section of the encapsulation polymer is trapezoidal, arc-shaped, triangular, rectangular, or step-shaped.

8. The manufacturing method according to claim 7, further comprising forming at least one reflecting coating on an upper surface, a lower surface or a side surface of the encapsulation polymer.

9. The manufacturing method according to claim 1, wherein the encapsulation polymer is made of transparent or translucent material.

10. The manufacturing method according to claim 1, wherein the encapsulation polymer has an upper portion and a lower portion that have different optical properties.

11. A manufacturing method of a backlight device, comprising steps of:
providing a light bar, a circuit board and a light guide plate;
bonding the light bar onto the circuit board; and
bonding the light bar to a matching surface of the light guide plate with polymer;
wherein the light bar is made by the manufacturing method according to claim 1.

12. A light bar, comprising:
a hard substrate;
multiple optical source chips electrically connected on the substrate, the multiple optical source chips being arranged along a length direction of the substrate in a predetermined spacing; and
encapsulation polymer covering top surfaces of the optical source chips and the substrate, and a topmost surface of the encapsulation polymer on the optical source chips and the substrate being located at the same level.

13. The light bar according to claim 12, further comprising at least one electrical pad formed on a side of the substrate, with the electrical pad connected with an electrode of at least one of the optical source chips.

14. The light bar according to claim 12, wherein the encapsulation polymer has a bottom surface abutted with the top surface of the substrate, a top surface opposite the bottom surface, and two reflecting surfaces connected with the bottom surface and the top surface, and the two reflecting surfaces in a first predetermined area are gradually narrowed from the top surface to the bottom surface, and the two reflecting surfaces in a second predetermined area are parallel one another.

15. The light bar according to claim 12, wherein a cross section of the encapsulation polymer is trapezoidal, arc-shaped, triangular, rectangular, or step-shaped.

16. The light bar according to claim 12, wherein the encapsulation polymer is made of transparent or translucent material.

17. The light bar according to claim 12, wherein the encapsulation polymer has an upper portion and a lower portion that have different optical properties.

18. A backlight device, comprising a light bar according to claim 12, a PCB connected to the light bar, and a light guide plate.
